(19) United States
(12) Patent Application Publication
(10) Pub. No.: US 2021/0396877 A1
(43) Pub. Date: Dec. 23, 2021

(54) SYSTEM AND METHOD FOR AN IMPROVED CHIRPED LIDAR

(71) Applicant: StereoVision Imaging, Inc., Calabasas, CA (US)

(72) Inventors: Hani Daniel, Rockville, MD (US); Stephan Schulz, Bethesda, MD (US)

(21) Appl. No.: 17/164,581

(22) Filed: Feb. 1, 2021

Related U.S. Application Data
(63) Continuation of application No. 16/906,018, filed on Jun. 19, 2020, now abandoned.
Application No. 16/906,018 is a continuation of application No. 15/405,411, filed on Jan. 13, 2017, now abandoned.
(60) Provisional application No. 62/279,083, filed on Jan. 15, 2016.

(51) Int. Cl. G01S 17/26; G01S 7/481; G01S 7/4912; G01S 17/58; G01S 17/34

(52) U.S. Cl. CPC G01S 17/26; G01S 7/4818; G01S 17/34; G01S 7/4917; G01S 17/58; G01S 7/4815

(57) ABSTRACT

A lidar comprises a first laser source configured to generate a first laser output at a first frequency and a second laser source configured to generate a second laser output at a second frequency, wherein the first frequency is different from the second frequency. A combining coupler combines the first laser output and the second laser output into a combined output. The combined output is carried by an optical fiber to a fiber tip where the combined output is transmitted as a transmit signal toward a target. A reflected portion of the transmit signal reflected back from a point on the target is received. A mixing coupler mixes the received reflected portion of the transmit signal with a second portion of the combined output and outputs a mixed signal. A wavelength filter separates the mixed signal into a first mixed signal corresponding to the first frequency of the first laser source and a second mixed signal corresponding to the second frequency of the second laser source. A first detector detects the first mixed signal, and a second detector mixed the second received signal. The detected first mixed signal and the detected second mixed signal may be used to determine a range and a Doppler velocity of the point on the target.

### CROSS-REFERENCE TO RELATED APPLICATIONS

This application is a continuation of U.S. application Ser. No. 16/906,018, which was filed on Jun. 19, 2020, and entitled “System and Method for an Improved Chirped Lidar;” which in turn is a continuation of U.S. application Ser. No. 15/405,411, which was filed on Jan. 13, 2017, and entitled “System and Method for an Improved Chirped Lidar;” which in turn claims priority to U.S. Provisional Application No. 62/279,083, which was filed on Jan. 15, 2016, and entitled “System and Method for an Improved Chirped Lidar.” Each of the foregoing applications is incorporated herein by reference in its entirety.

### FIELD OF THE INVENTION

The invention is generally related to a lidar system (i.e., laser radar system), and more particularly, using wavelength division multiplexing filters in a chirped, frequency-modulated continuous-wave (“FMCW”) lidar system.

### BACKGROUND OF THE INVENTION

Various conventional lidar systems (i.e., laser radar systems) employ coherent detection, in which a received optical signal is combined with a mixing or reference optical signal to produce an interference signal. Conventional chirped lidar systems typically maintain a separate optical path for each of two or more chirped signals up until such signals are transmitted to a target. Similarly, conventional chirped lidar systems also typically maintain a separate optical path for each of one or more received signals reflected from the target to combine such received signals with separate mixing reference signals. As such, conventional chirped lidar systems typically employ a significant number of optical components and optical fibers.

What is needed is a chirped lidar system that employs fewer optical components and fewer lengths of optical fibers.

### SUMMARY OF THE INVENTION

According to various implementations of the invention, a lidar utilizes wave division multiplexing to reduce an overall number of required optical components. In some implementations of the invention, such a lidar includes a first laser source configured to generate a first laser output at a first frequency and a second laser source configured to generate a second laser output at a second frequency, wherein the first frequency is different from the second frequency. In some implementations of the invention, the lidar includes a combining coupler, which combines the first laser output and the second laser output into a combined output. In some implementations of the invention, the combined output is carried by an optical fiber to its fiber tip where the combined output is transmitted as a transmit signal toward a target. In some implementations of the invention, a reflected portion of the transmit signal reflected back from a point on the target is received. In some implementations of the invention, the lidar includes a mixing coupler, which mixes the received reflected portion of the transmit signal with a second portion of the combined output and outputs a mixed signal. In some implementations of the invention, the lidar includes a wavelength filter, which separates the mixed signal into a first mixed signal corresponding to the first frequency of the first laser source and a second mixed signal corresponding to the second frequency of the second laser source. In some implementations of the invention, the lidar includes a first detector that detects the first mixed signal, and a second detector that detects the second mixed signal. In some implementations of the invention, the lidar uses the two detected mixed signals to determine both a range and a Doppler velocity of the point on the target.

These implementations, their features and other aspects of the invention are described in further detail below.

### BRIEF DESCRIPTION OF THE DRAWINGS

FIG. 1 illustrates an improved chirped lidar system in accordance with various implementations of the invention.

FIG. 2 illustrates an improved chirped lidar system with five output beams according to various implementations of the invention.

FIG. 3 illustrates an output multiplexer portion of the improved chirped lidar system of FIG. 2 in further detail in accordance with various implementations of the invention.

FIG. 4 illustrates a detector portion of the improved chirped lidar system of FIG. 2 in further detail in accordance with various implementations of the invention.

FIG. 5 illustrates a source portion of the improved chirped lidar system of FIG. 2 in further detail in accordance with various implementations of the invention.

FIG. 6 illustrates a wavelength filter in accordance with various implementations of the invention.

FIG. 7 illustrates a conventional chirped lidar system for a single output beam.

### DETAILED DESCRIPTION

Conventional chirped lidar systems employ two or more laser sources to provide chirped lidar signals. These chirped lidar signals, when incident upon and reflected back from a point on a target, may be detected and used to determine a range and an instantaneous Doppler velocity of the point on the target. Such a lidar system is described in U.S. Pat. No. 7,511,824, entitled “Chirped Coherent Laser Radar System and Method,” which issued on Mar. 31, 2009, and which is assigned to Digital Signal Corporation of Chantilly, Va. The foregoing patent is incorporated herein by reference as if reproduced below in its entirety.

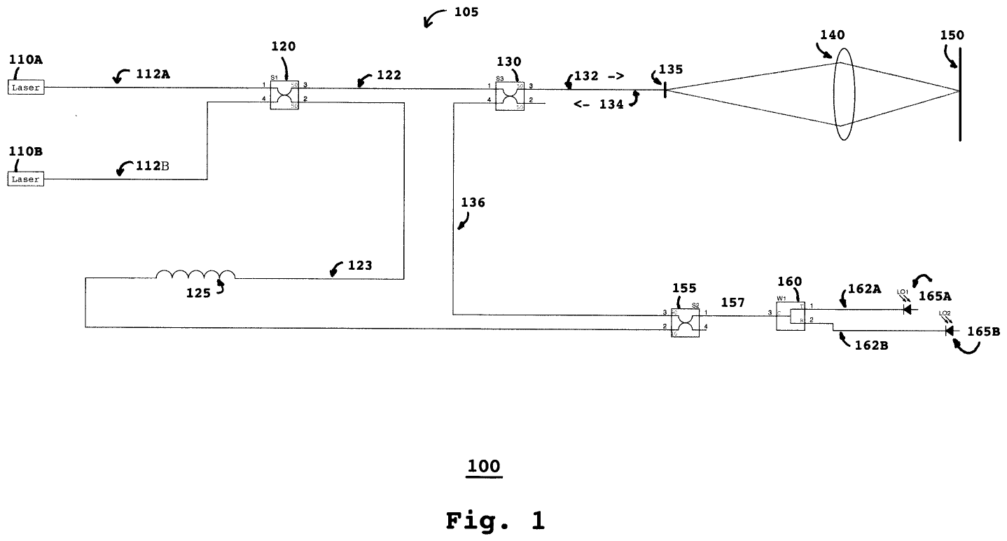

FIG. 1 illustrates an optical path 105 for an improved chirped lidar system 100 according to various implementations of the invention. More particularly, chirped lidar system 100 corresponds to a single “beam” comprised of two independent chirped lidar signals that when incident upon and reflected from a point on a target (such as a target 150) may be detected and used to determine a range and an instantaneous Doppler velocity of the point on the target. Laser sources 110 (illustrated in FIG. 1 as a first laser source 110A and a second laser source 110B) each provide a lidar signal 112 (illustrated in FIG. 1 as a first lidar signal 112A and a second lidar signal 112B). In some implementations of the invention, lidar signals 112 are chirped lidar signals. In some implementations of the invention, lidar signals 112 differ in wavelength from one another. In some implementations of the invention, lidar signals 112 differ in wavelength from one another by approximately 1.6 nanometers, although the wavelengths may differ by other amounts as would be appreciated. In some implementations, the wavelengths differ by more than a 35 GHz modulation depth as would be appreciated. In some implementations of the invention, laser source 110A outputs a lidar signal with an unmodulated wavelength of 1550.918 nm and laser source 110B outputs a lidar signal with an unmodulated wavelength of 1549.315 nm.

In some implementations of the invention, lidar optical path 105 includes a combining coupler 120. In some implementations of the invention, combining coupler 120 may be an optical device that combines two input light paths into at least one output light path. In some implementations of the invention, some combining couplers described herein may be fiber-optic devices as would be appreciated. In some implementations of the invention, some combining couplers may be fiber-optic fusion combining couplers or wavelength filters as would be appreciated. In some implementations of the invention, some combining couplers may be micro-optic devices as would be appreciated. Combining coupler 120 receives first chirped lidar signal 112A and second chirped lidar signal 112B and combines them to output a combined lidar signal 122 and a reference signal 123 (sometimes also referred to as a mixing signal or local oscillator signal as would be appreciated).

In some implementations of the invention, lidar optical path 105 includes a separator 130. In some implementations of the invention, separator 130 may be an optical device that splits an input light path into two output light paths, each at a predetermined power ratio relative to the input light path. In some implementations of the invention, some separators described herein may be fiber-optic devices as would be appreciated. In some implementations of the invention, some separators may be fiber-optic fusion separators as would be appreciated. In some implementations of the invention, some separators may be micro-optic devices as would be appreciated. Separator 130 allows a portion of combined lidar signal 122 to propagate to fiber tip 135 as a transmit signal 132 and to be transmitted toward target 150. In some implementations of the invention, a portion of transmit signal 132 is incident upon and reflected back from target 150 and returned to fiber tip 135 and propagates back to separator 130 as a returned signal 134. In some implementations of the invention, separator 130 separates a portion of the returned signal 134 from transmit signal 132 and outputs this portion as a received signal 136. Separator 130 ensures that received signal 136 does not include significant amounts of transmit signal 132 such that transmit signal 132 and receive signal 134 do not interfere (or have minimal interference) with one another. In some implementations of the invention, this arrangement facilitates uses of a same length of optical fiber to carry both transmit signal 132 and returned signal 134 from separator 130 to fiber tip 135. Separator 130 may be implemented for example as a fiber-optic splitter, as a circulator or, if the receive signal returns in a polarization orthogonal to the transmit signal, as a polarizing beam splitter. In FIG. 1 (and elsewhere), separator 130 is illustrated as a splitter as an example, but other components may be used as would be appreciated.

In some implementations of the invention, a portion of transmit signal 132 is incident upon and reflected back from target 150 and returned to a tip of a separate fiber (not otherwise illustrated) as used by a bi-static lidar, thereby eliminating the need for separator 130 as would be appreciated. Such implementations of the invention may utilize a dual-core optical fiber or fusion-tapered combination of two fibers or other two fiber implementations as would be appreciated.

As discussed above, separator 130 outputs received signal 136 which is a version of received signal 134 from fiber tip 135 after encountering some insertion loss by separator 130. In some implementations of the invention, optical path 105 includes a mixing coupler 155. Mixing coupler 155 mixes received signal 136 with a delayed version of reference signal 123. As would be appreciated, in some implementations of the invention, reference signal 123 is delayed by a delay line 125 corresponding to an expected roundtrip time of combined lidar signal 122 through separating splitter 130, to target 150 and back through separator 130 and to mixing coupler 155. In some implementations of the invention, delay 125 may be absent or differ significantly from the roundtrip delay described above as would be appreciated. Mixing coupler 155 outputs a mixed signal 157.

In some implementations of the invention, optical path 105 includes a wavelength filter 160. Wavelength filter 160 receives mixed signal 157 and separates it into two output signals 162 (illustrated in FIG. 1 as a first output signal 162A and a second output signal 162B) based on wavelength. Each of these two signals 162 output from wavelength filter 160 correspond to a respective one of the wavelengths of laser sources 110. In other words, output signal 162A corresponds to a received portion of first lidar signal 112A from laser source 110A that was reflected back from target 150 and output signal 162B corresponds to a received portion of second lidar signal 112B from laser source 110B that was reflected back from target 150.

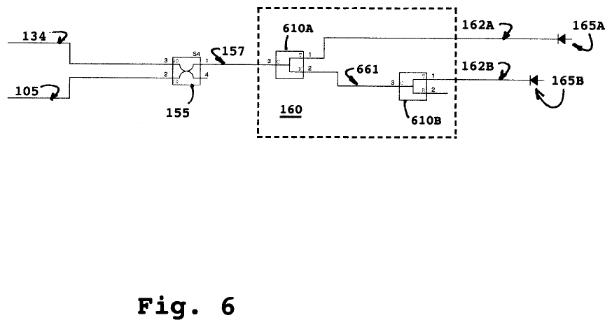

In some implementations of the invention such as that illustrated in FIG. 6, separation of mixed signal 157 into two receive signals 162A and 162B may be achieved by using more than one wavelength filter 610 (illustrated in FIG. 6 as a wavelength filter 610A and a wavelength filter 610B) where an intermediate signal 661 is passed from a first wavelength filter 610A to a second wavelength filter 610B for improved separation of the reflected portions of the two lidar signals 112A and 112B. In some implementations of the invention, any single component or combination of components that achieves the separation of the different wavelengths may be used as would be appreciated.

In some implementations of the invention, optical path 105 includes a pair of detectors 165 (illustrated in FIG. 1 as a first detector 165A and a second detector 165B). Output signal 162A is applied to first detector 165A and output signal 162B is applied to second detector 165B. Outputs from detectors 165 are subsequently processed to provide a range measurement and a Doppler velocity measurement for the point on target 150 as would be appreciated.

In some implementations of the invention, optical path 105 may include one or more attenuators (not otherwise illustrated) to reduce a power level output from fiber tip 135 to provide certain levels of safety (e.g., eye safety, etc.) or to reduce a power level of the reference signal as would be appreciated.

One benefit of lidar system 100 is a reduced number of optical components in comparison to conventional lidar systems. In some implementations of the invention, lidar system 100 utilizes roughly one-half of the number of optical components utilized by conventional lidar systems. In addition, lidar system 100 requires fewer lengths of optical fiber. This is due to the sharing of much of optical path 105 by two signals of differing wavelength, in particular delay 125 and mixing coupler 155. In some implementations of the invention, the lidar system may use multiple beams and multiple fiber tips to obtain multiple simultaneous measurements of range and Doppler velocity from separate points of the target. In such lidar systems with multiple beams, more splitters and combining couplers are used to generate the different portions of the lidar signal. Sharing the optical path by two signals of differing wavelength avoids duplication of the fiber paths and components, leading to significant savings in the required number of components and splices.

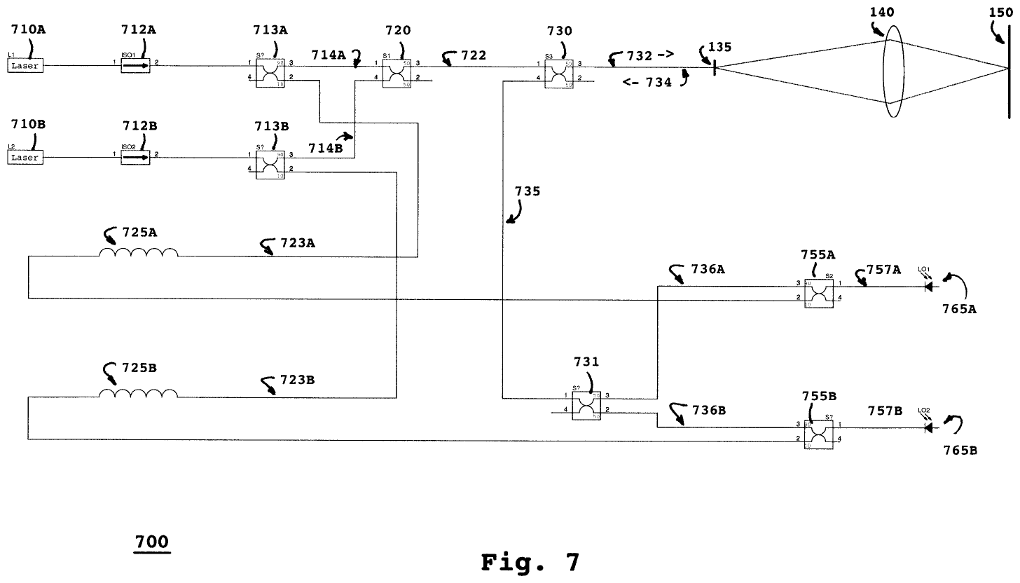

FIG. 7 illustrates a conventional lidar system 700. In conventional lidar system 700 using two or more lasers 710 to generate two or more lidar signals 714A and 714B, received signal 734 (i.e., return signal) from each beam must be split into multiple parts to be separately mixed with a mixing signal 723A or 723B (i.e., reference signal) from each of the laser sources 710A or 710B, respectively. This splitting of the received signal by separator 731 introduces a decrease in amplitude of received signal 734 and hence, results in a decrease in system sensitivity. Hence, another benefit of lidar system 100 is that received signal 136 experiences no such decrease in amplitude, compared to a loss of about 3 dB in a conventional system with two laser sources. This in turn results in a roughly 3 dB gain in receive sensitivity of lidar system 100.

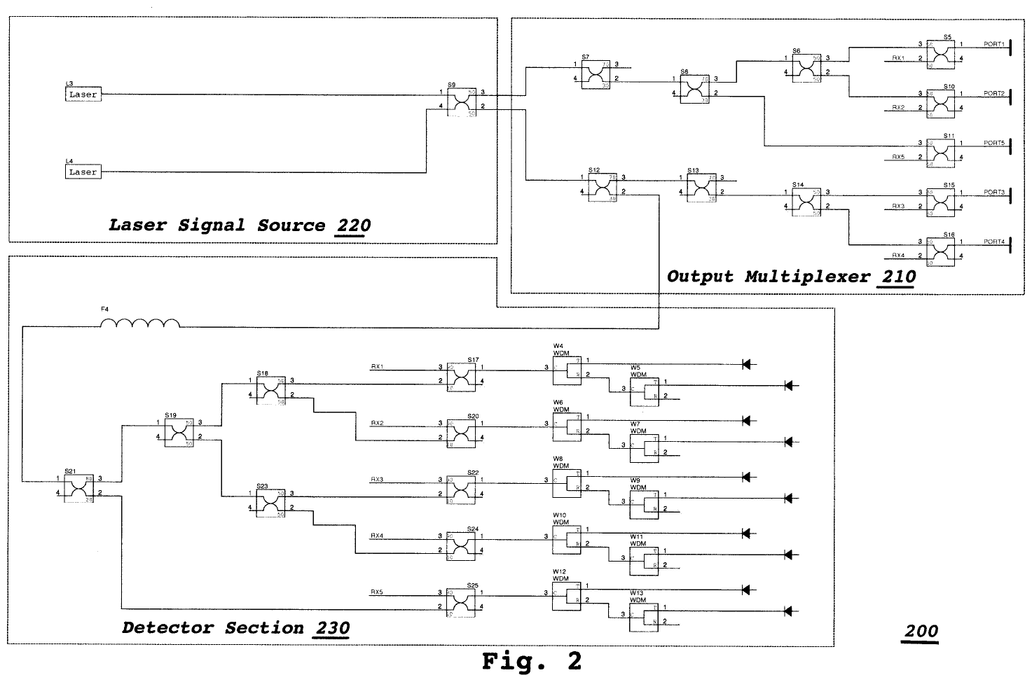

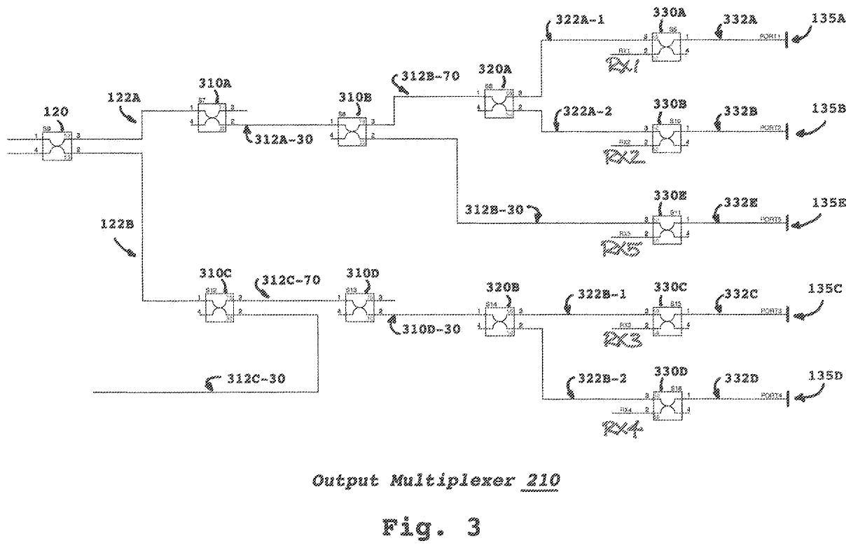

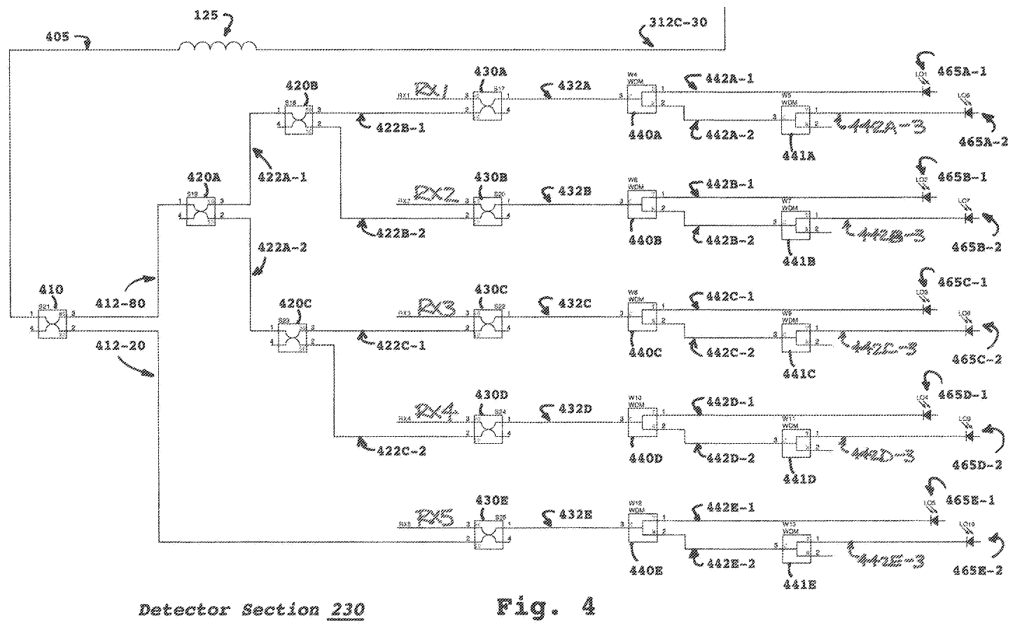

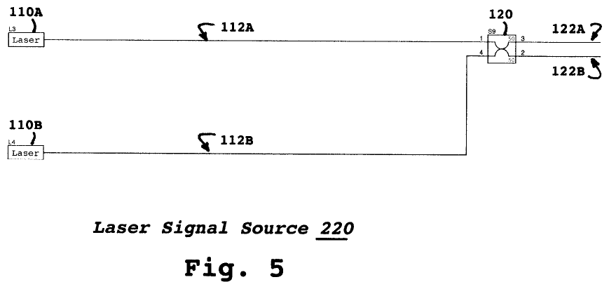

As discussed above, FIG. 1 illustrates lidar system 100 for a single output beam (i.e., a single pair of lidar signals 112 ultimately output from fiber tip 135). In various implementations of the invention, lidar system 100 may be configured to provide two or more output beams. In some implementations of the invention, lidar system 100 may be configured to provide four output beams. FIGS. 2-5 illustrates a lidar system 200 with five output beams (i.e., five pairs of lidar signals 112 ultimately output from five fiber tips (illustrated in FIG. 2 as “PORT1”, “PORT2”, “PORT3”, “PORT4”, and “PORT5”) according to various implementations of the invention. Lidar system 200 includes an output multiplexer section 210 (illustrated in further detail in FIG. 3); a laser signal source section 220 (illustrated in further detail in FIG. 5); and a detector section 230 (illustrated in further detail in FIG. 4). Each of these sections is now described.

In reference to FIG. 3, in some implementations of the invention, output multiplexer section 210 receives combined lidar signal 122 from combining coupler 120 as illustrated. More particularly, combining coupler outputs a 50% portion of combined lidar signal as a first lidar signal portion 122A and a second lidar signal portion 122B. In some implementations, output multiplexer section 210 includes four 70/30 beam splitters 310 (illustrated in FIG. 3 as a first 70/30 beam splitter 310A, a second 70/30 beam splitter 310B, a third 70/30 beam splitter 310C, and a fourth 70/30 beam splitter 310D). Each of 70/30 beam splitters 310 splits an input signal into two components with 70% of the power of the input signal transferred to a first output and 30% of the power of the input signal transferred to a second output.

In some implementations of the invention, first 70/30 beam splitter 310A receives first lidar signal portion 122A and splits off a 30% component 312A-30. Second 70/30 beam splitter 310B receives 30% component 312A-30 from first 70/30 beam splitter 310A and splits it into two components: a 70% component 312B-70 and a 30% component 312B-30.

In some implementations of the invention, third 70/30 beam splitter 310C receives second lidar signal portion 122B and splits it into two components: a 70% component 312C-70 and a 30% component 312C-30. Fourth 70/30 beam splitter 310D receives 70% component 312C-70 from third 70/30 beam splitter 310C and splits off a 30% component 312D-30.

In some implementations of the invention, output multiplexer section includes two 50/50 beam splitters 320 (illustrated in FIG. 3 as a first 50/50 beam splitter 320A and a second 50/50 beam splitter 320B). First 50/50 beam splitter 320A receives 70% component 312B-70 from second 70/30 beam splitter 310B and splits it into two components: a 50% component 322A-1 and a 50% component 322A-2. Second 50/50 beam splitter 320B receives 30% component 312D-30 from fourth 70/30 beam splitter 310D and splits it into two components: a 50% component 322B-1 and a 50% component 322B-2.

Applying beam splitters 310, 320 (and their associated split ratios) to combined lidar signal 122 through output multiplexer section 210 results in six versions of combined lidar signal 122: component 322A-1 corresponding to roughly 10.5% of the power of combined lidar signal 122; component 322A-2 corresponding to roughly 10.5% of the power of combined lidar signal 122; component 322B-1 corresponding to roughly 10.5% of the power of combined lidar signal 122; component 322B-2 corresponding to roughly 10.5% of the power of combined lidar signal 122; and component 312B-30 corresponding to roughly 9% of the power of combined lidar signal 122. As stated, four of these signals have roughly the same power level with the fifth signal having slightly less. Signal 312C-30 is a sixth version of the combined lidar signal 122 with approximately 30% of the power of the combined lidar signal 122. Signal 312C-30 is used as mixing/reference signal, routed to delay line 125 and further split into components in detector section 230.

In some implementations of the invention, output multiplexer section 210 includes five separators 330 (illustrated in FIG. 3 as a fiber-optic splitter 330A, a fiber-optic splitter 330B, a fiber-optic splitter 330C, a fiber-optic splitter 330D, and a fiber-optic splitter 330E). Each separator 330 receives one component of the combined transmit signal 122: component 322A-1, component 322A-2, component 322B-1, component 322B-2, and component 312B-30 as illustrated. Each separator 330 outputs a transmit signal 332 (illustrated as a transmit signal 332A from separator 330A, a transmit signal 332B from separator 330B, a transmit signal 332C from separator 330C, a transmit signal 332D from separator 330D, and a transmit signal 332E from separator 330E). Each separator 330 also outputs a receive signal 234 (illustrated as a receive signal RX1 from separator 330A, a receive signal RX2 from separator 330B, a receive signal RX3 from separator 330C, a receive signal RX4 from separator 330D, and a receive signal RX5 from separator 330E). Each separator 330 functions in a manner similar to separator 130 as discussed above. As discussed above with regard to FIG. 3, in some implementations of the invention, output multiplexer section 210 splits combined lidar signal 122 into five components, one for each of five output beams. In some implementations of the invention, output multiplexer section 210 is configured to split combined lidar signal 112 into two or more components as would be appreciated.

To accommodate the five transmit signals 332 and their accompanying receive signals RX1, RX2, RX3, RX4, and RX5, additional mixing couplers and wavelength filters may need to be included in lidar 100. FIG. 4 illustrates a detector section 230 that may be used in conjunction with various implementations of the invention. In some implementations of the invention, detector section 230 includes an 80/20 beam splitter 410 and three beam splitters 420 (illustrated as a beam splitter 420A, a beam splitter 420B, and a beam splitter 420C). In some implementations of the invention, 80/20 beam splitter 410 receives delayed signal 405 corresponding to a delayed version of a portion of combined lidar signal 122 from delay line 125. 80/20 beam splitter 410 splits delayed signal 405 into two components: an 80% component 412-80 and a 20% component 412-20. Beam splitter 420A splits component 412-80 into two roughly equal components: a component 422A-1 and a component 422A-2. Beam splitter 420B splits component 422A-1 into two roughly equal components: a component 422B-1 and a component 422B-2. Beam splitter 420C splits component 422A-2 into two roughly equal components: a component 422C-1 and a component 422C-2. In some implementations of the invention, 80/20 beam splitter 410 and beam splitters 420, in effect, divide delayed signal 405 into five equal portions of reference signal components, each corresponding to roughly 3% of combined lidar signal 122.

In some implementations of the invention, detector section 230 includes five mixing couplers 430 (illustrated in FIG. 4 as a mixing coupler 430A, a mixing coupler 430B, a mixing coupler 430C, a mixing coupler 430D, and a mixing coupler 430E). Each mixing coupler receives a corresponding received signal and a portion of delayed signal 405 and outputs a mixed signal 432. More particularly, mixing coupler 430A receives received signal RX1 and component 422B-1, mixes its two input signals and outputs a mixed signal 432A; mixing coupler 430B receives received signal RX2 and component 422B-2, mixes its two input signals and outputs a mixed signal 432B; mixing coupler 430C receives received signal RX3 and component 422C-1, mixes its two input signals and outputs a mixed signal 432C; and mixing coupler 430D receives received signal RX4 and component 422C-2, mixes its two input signals and outputs a mixed signal 432D; and mixing coupler 430E receives received signal RX5 and component 412-20, mixes its two input signals and outputs a mixed signal 432E.

In some implementations of the invention, mixing couplers 430 may correspond to a beam splitter with a 90/10 split ratio or any other suitable, asymmetric split ratio in order to facilitate implementation of an asymmetric single-ended detector as described in U.S. patent application Ser. No. 14/249,085, entitled “System and Method for Using Combining Couplers with Asymmetric Split Ratios in a Lidar System,” filed on Apr. 9, 2014, and which is assigned to Digital Signal Corporation of Chantilly, Va. The foregoing patent application is incorporated herein by reference as if reproduced below in its entirety.

In some implementations of the invention, detector section 230 includes five wavelength filters that separates each mixed signal 432 into separate components based on the wavelengths of laser sources 110 as discussed above. In some implementations, as discussed above with regard to FIG. 6 and as illustrated in FIG. 4, each such wavelength filter may include one or more wavelength filter components to provide the desired separation of the individual wavelengths. Accordingly, in some implementations of the invention, detector section 230 includes five pairs of wavelength filters (illustrated in FIG. 4 as wavelength filters 440A and 441A, wavelength filters 440B and 441B, wavelength filters 440C and 441C, wavelength filters 440D and 441D, and wavelength filters 440E and 441E). Each wavelength filter 440 receives a corresponding mixed signal 432 and separates it into two output signals 442-1 and 442-2 based on the wavelength of one of laser sources 110 (illustrated in FIG. 4 as a first output signal 442A-1 and an intermediate signal 442A-2 output from wavelength filter 440A; a first output signal 442B-1 and an intermediate signal 442B-2 output from wavelength filter 440B; a first output signal 442C-1 and an intermediate signal 442C-2 output from wavelength filter 440C; a first output signal 442D-1 and an intermediate signal 442D-2 output from wavelength filter 440D; and a first output signal 442E-1 and an intermediate signal 442E-2 output from wavelength filter 440E). Each wavelength filter 441 receives intermediate signal 442x-2 from wavelength filter 440 and generates a second output signal 442x-3 based on the wavelength of the other of laser sources 110 (illustrated in FIG. 4 as a wavelength filter 441A receiving intermediate signal 442A-2 and generating a second output signal 442A-3; a wavelength filter 441B receiving intermediate signal 442B-2 and generating a second output signal 442B-3; a wavelength filter 441C receiving intermediate signal 442C-2 and generating a second output signal 442C-3; a wavelength filter 441D receiving intermediate signal 442D-2 and generating a second output signal 442D-3; and a wavelength filter 441E receiving intermediate signal 442E-2 and generating a second output signal 442E-3. Each of two signals 442x-1 and 442x-3 output from wavelength filters 440, 441 corresponds to a respective one of the wavelengths of laser sources 110 as discussed above.

As illustrated in FIG. 4, the filters utilized by wavelength filters 440, 441 are different from one another; namely, the first output of wavelength filter 440 may correspond to a bandpass filter applied to the input signal whereas a second output of wavelength filter 440 may correspond to a bandstop filter applied to the input signal. In order to condition these signals in a similar manner, a second wavelength filter 441 may be used (illustrated as a wavelength filter 441A, a wavelength filter 441B, a wavelength filter 441C, a wavelength filter 441D, and a wavelength filter 441E). In such implementations of the invention, wavelength filters 440 provide a bandpass filter corresponding to the wavelength of first laser source 110A and wavelength filters 441 provide a bandpass filter corresponding to the wavelength of second laser source 110B. In such implementations of the invention, the output of wavelength filter 440 corresponding to the bandstop filter for the wavelength of first laser source 110A is applied to wavelength filter 441 as would be appreciated.

In some implementations of the invention, detector section 230 includes five pairs of detectors 465 (illustrated in FIG. 4 as a detector 465A-1, a detector 465A-2, a detector 465B-1, a detector 465B-2, a detector 465C-1, a detector 465C-2, a detector 465D-1, a detector 465D-2, a detector 465E-1, and a detector 465E-2). Output signal 442A-1 is applied to detector 465A-1 and output signal 442A-3 is applied to second detector 465A-2; output signal 442B-1 is applied to detector 465B-1 and output signal 442B-3 is applied to second detector 465B-2; output signal 442C-1 is applied to detector 465C-1 and output signal 442C-3 is applied to second detector 465C-2; output signal 442D-1 is applied to detector 465D-1 and output signal 442D-3 is applied to second detector 465D-2; and output signal 442E-1 is applied to detector 465E-1 and output signal 442E-3 is applied to second detector 465E-2. Outputs from each corresponding pair of detectors 465 are subsequently processed to provide a range measurement and a Doppler velocity measurement for a respective point on target 150 as would be appreciated.

FIG. 5 illustrates a source section 220 of lidar system 200. Laser sources 110 (illustrated in FIG. 5 as a first laser source 110A and a second laser source 110B) each provide a lidar signal 112 (illustrated in FIG. 5 as a first lidar signal 112A and a second lidar signal 112B). In some implementations of the invention, lidar signals 112 are chirped lidar signals. In some implementations of the invention, lidar signals 112 differ in wavelength from one another. In some implementations of the invention, lidar signals 112 differ in wavelength from one another by approximately 1.6 nanometers, although the wavelengths may differ by other amounts as would be appreciated. In some implementations, the wavelengths differ by more than a 35 GHz modulation depth as would be appreciated. In some implementations of the invention, laser source 110A outputs a lidar signal with an unmodulated wavelength of 1550.918 nm and laser source 110B outputs a lidar signal with an unmodulated wavelength of 1549.315 nm.

Combining coupler 120 receives first chirped lidar signal 112A and second chirped lidar signal 112B and combines them as would be appreciated. Combining coupler 120 outputs a combined lidar signal 122 in the form of two components, 122A and 122B, of about equal power, both including about equal amounts of first chirped lidar signal 112A and second chirped lidar signal 112B.

The various implementations of the invention discussed above may be configured for use in a combined lidar and video system such as that described in U.S. Pat. No. 8,717,545 entitled “System and Method for Generating Three Dimensional Images using Lidar and Video Measurements,” which issued on May 6, 2014, (the “'545 patent”) and which is assigned to Digital Signal Corporation of Chantilly, Va. The foregoing patent is incorporated herein by reference as if reproduced below in its entirety. In some implementations of the invention, transmit signals 332A-D correspond to four beams used to scan targets as described in the '545 patent and transmit signal 332E corresponds to an overscan beam as described in the '545 patent.

While the invention has been described herein in terms of various implementations, it is not so limited and is limited only by the scope of the following claims, as would be apparent to one skilled in the art. These and other implementations of the invention will become apparent upon consideration of the disclosure provided above and the accompanying figures. In addition, various components and features described with respect to one implementation of the invention may be used in other implementations as well.

What is claimed is:

1. A lidar comprising:
a first laser source configured to generate a first laser output at a first frequency;
a second laser source configured to generate a second laser output at a second frequency, wherein the first frequency is different from the second frequency;
a combining coupler configured to combine the first laser output and the second laser output into a combined output;
at least one fiber configured to output a first portion of the combined output as a transmit signal toward a target and to receive a reflected portion of the transmit signal reflected back from the target;
a mixing coupler configured to mix the received reflected portion of the transmit signal with a second portion of the combined output and output a mixed signal;
a wavelength filter configured to separate the mixed signal into a first mixed signal corresponding to the first frequency and a second mixed signal corresponding to the second frequency;
a first detector configured to detect the first mixed signal; and
a second detector configured to detect the second mixed signal.

2. The lidar of claim 1, further comprising:
a separator configured to:
receive the combined output,
output a transmit signal onto the at least one fiber, the transmit signal corresponding to a portion of the combined output,
receive a return signal from the at least one fiber, and
output the return signal as a received signal.

3. The lidar of claim 1, further comprising:
a delay configured to:
receive the second portion of the combined output, and
output a delayed version of the received second portion of the combined output to the mixing coupler.

4. The lidar of claim 1, wherein the wavelength filter comprises:
a first wavelength filter configured to separate and output the first mixed signal corresponding to the first frequency from the mixed signal and output a remaining portion of the mixed signal; and
a second wavelength filter configured to separate and output the second mixed signal corresponding to the second frequency from the remaining portion of the mixed signal.

5. A lidar comprising:
a first laser source configured to generate a first laser output at a first frequency;
a second laser source configured to generate a second laser output at a second frequency, wherein the first frequency is different from the second frequency;
a combining coupler configured to combine the first laser output and the second laser output into a combined output;
an output multiplexer configured to split the combined output into five transmit signals, each of the five transmit signals having approximately a same power level;
a fiber for each of the five transmit signals configured to output a respective one of the five transmit signals toward a target and to receive a reflected portion of the respective one of the five transmit signals reflected back from the target;
a mixing coupler for each of the five transmit signals configured to mix each of the received reflected portion of the respective one of the five transmit signals with a second portion of the combined output and output a corresponding mixed signal for each of the five transmit signals;
a wavelength filter for each of the five transmit signals configured to separate each of the corresponding mixed signals into a first mixed signal corresponding to the first frequency and a second mixed signal corresponding to the second frequency;
a first detector for each of the five transmit signals configured to detect the first mixed signal; and
a second detector for each of the five transmit signals configured to detect the second mixed signal.

6. A method comprising:
generating a first laser output at a first frequency from a first laser source;
generating a second laser output at a second frequency from a second laser source, wherein the first frequency is different from the second frequency;
combining the first laser output and the second laser output into a combined output;
transmitting a first portion of the combined output as a transmit signal toward a target;
receiving a reflected portion of the transmit signal reflected back from a point on the target;
mixing the received reflected portion of the transmit signal with a second portion of the combined output to produce a mixed signal;
separating, via a wavelength filter, the mixed signal into a first mixed signal corresponding to the first frequency and a second mixed signal corresponding to the second frequency;
detecting the first mixed signal via a first detector;
detecting the second mixed signal via a second detector; and
determining a range and a Doppler velocity for the point on the target from the detected first mixed signal and the detect second mixed signal.
